(19) United States
(12) Patent Application Publication
(10) Pub. No.: US 2011/0148870 A1
(43) Pub. Date: Jun. 23, 2011

(54) METHOD AND APPARATUS FOR GENERATING GRAPHIC TENTACLE MOTIONS

(75) Inventors: Myung-Gyu KIM, Daejeon (KR); Man-Kyu Sung, Daejeon (KR); Sang-Won Ghyme, Daejeon (KR); Sung-June Chang, Daejeon (KR); Il-Kwon Jeong, Daejeon (KR); Byoung-Tae Choi, Daejeon (KR)

(73) Assignee: Electronics and Telecommunications Research Institute, Daejeon (KR)

(21) Appl. No.: 12/973,533

(22) Filed: Dec. 20, 2010

(30) Foreign Application Priority Data
Dec. 21, 2009 (KR) 10-2009-0128396

(51) Int. Cl. G06T 13/00; G06T 15/00

(52) U.S. Cl. 345/419

(57) ABSTRACT

Disclosed herein is a method and apparatus for generating graphic tentacle motions. In the method, a 3D tentacle is divided into a 1D center line and a 2D surface based on information about an initial mesh of the 3D tentacle. New locations of sample points of the center line in a new frame are determined from initial locations of sample points of the center line, based on a tentacle root motion. New locations of sample points of the surface in the new frame are determined from initial locations of sample points of the surface, based on both the initial locations of the center line sample points and the tentacle root motion. The surface is coupled to the center line using the locations of the sample points of both the center line and the surface in the new frame.

### CROSS REFERENCE TO RELATED APPLICATIONS

This application claims the benefit of Korean Patent Application No. 10-2009-0128396 filed on Dec. 21, 2009, which is hereby incorporated by reference in its entirety into this application.

### BACKGROUND OF THE INVENTION

1. Technical Field

The present invention relates generally to a method and apparatus for generating graphic tentacle motions, and, more particularly, to a method and apparatus for generating graphic tentacle motions which generates high quality and realistic graphic tentacle motions at an efficient speed in a scheme for visualizing the shapes and motions of a tentacle in computer graphics.

2. Description of the Related Art

As is well known to those skilled in the art, methods of modeling tentacle simulations include mass-spring modeling for linking point-masses, in which mass is assigned to the vertices of a three-dimensional (3D) volumetric mesh of a tentacle, to neighboring point-masses via springs. The advantage of such a modeling method is that the implementation of simulation is greatly simplified and is performed rapidly.

Further, in the deformer of Maya, which is a commercial software, a tentacle is modeled using the Spline curve based on inverse dynamics. This modeling method animates the deformation and vibrations of a tentacle using the free-form deformation of sample points on the Spline curve. This method is advantageous in that various functions of the commercial software Maya can be used in simulating the tentacle motion.

Recently, Chriswell proposed a tentacle model based on a multi-rigid body model which is used in robotics and in articulated object animation, and applied the tentacle model to the film “Pirates of the Caribbean.” In this model, each tentacle is approximated to a linear multi-rigid body, so that a dynamics engine can be simply deformed and used. Further, the wriggling of each tentacle is represented using the internal force of sine waves.

However, the above-described conventional technology does not yet solve the problems in that since point-masses and springs are distributed throughout the entire 3D volume in a volumetric mass-spring model, the time required for modeling increases, and in that the volumetric mass-spring model desirably represents uniform deformation, but does not accurately represent longitudinal deformation and vibrations in thick string-shaped tentacles.

Meanwhile, since the deformer of Maya uses the Spline curves based on inverse dynamics, the longitudinal deformation and vibrations of tentacles can be represented. However, since this scheme uses free-form deformation, a problem arises in that a designer must perform a large number of manual operations, and each tentacle is shown as if it penetrates through a body. That is, this method is disadvantageous in that an excessively large number of manual operations are required in order to perform detail representation, so that animation is not rapidly and automatically generated.

Furthermore, the models of Chriswell are models in which multiple rigid bodies are connected, and are disadvantageous because it is difficult to physically generate detail bending or twisting of the tentacles due to the characteristics of rigid bodies. Further, it is possible to represent the wriggling of tentacles using the internal force of sine waves, but such wriggling occurs too periodically, and a destruction simulation function such as the cutting of tentacles is not present.

### SUMMARY OF THE INVENTION

Accordingly, the present invention has been made keeping in mind the above problems occurring in the prior art, and an object of the present invention is to provide a method and apparatus for generating graphic tentacle motions, which models a tentacle in such a way as to divide the tentacle into a center line and a surface, thus shortening the time required for calculation compared to the simulation of the entire 3D volume.

Another object of the present invention is to provide a scheme for dividing a tentacle into a center line and a surface and simulating the deformation of the one-dimensional center line using a physical particle system, thus enabling detail representation of the bending or twisting of the tentacle to be performed without causing unnaturalness such as the penetration of the tentacle into a body.

A further object of the present invention is to provide a scheme for dividing a tentacle into a center line and a surface, resolving vibrations of the two-dimensional surface into eigen-modes, and automatically generating the motions of the surface by coupling finite typical vibration eigen-modes, and to provide a scheme for enabling a destruction simulation to be performed when an external force equal to or greater than a threshold is applied to a region of the tentacle simply set by a user.

In accordance with an aspect of the present invention to accomplish the above objects, there is provided a method of generating graphic tentacle motions, including dividing a three-dimensional (3D) tentacle into a one-dimensional (1D) center line and a two-dimensional (2D) surface based on information about an initial mesh of the 3D tentacle; determining new locations of sample points of the 1D center line in a new frame from initial locations of sample points of the 1D center line, based on a tentacle root motion which is externally applied; determining new locations of sample points of the 2D surface in the new frame from initial locations of sample points of the 2D surface, based on both the initial locations of the 1D center line sample points and the tentacle root motion which is externally applied; and coupling the 2D surface to the 1D center line using the locations of the sample points of both the 1D center line and the 2D surface in the new frame, thus generating a shape of the tentacle.

Preferably, the method may further include repeatedly performing the line-surface coupling on new frames, thus generating a shape of the tentacle that is deformed over time.

Preferably, determining the locations of the sample points of the 1D center line may to further include determining initial locations of the sample points of the 1D center line based on the externally applied tentacle root motion; and determining new locations of the sample points of the center line, which define a shape of the center line in a subsequent frame, based on both locations of the sample points of the 1D center line and the externally applied tentacle root motion.

Preferably, determining the locations of the sample points of the 2D surface may include determining initial locations of the sample points of the 2D surface based on the externally applied tentacle root motion; and determining new locations of sample points of the 2D surface in the subsequent frame based on the old locations of the sample points of the 2D surface, the new locations of the sample points of the 1D center line, and the externally applied tentacle root motion.

Preferably, distribution of the sample points of the 1D center line may be performed to consider a geometrical structure of the tentacle to increase a sense of reality, and use adaptive sampling in which a number of sample points distributed at the tentacle root and a number of sample points distributed at the tentacle tip are differently set.

Preferably, distribution of the sample points of the 2D surface may be performed to consider a geometrical structure of the tentacle to increase a sense of reality, and use adaptive sampling in which a number of sample points distributed at the tentacle root and a number of sample points distributed at the tentacle tip are differently set.

Preferably, the method may further include applying a physical particle simulation, which includes at least one of twisting, bending and destruction, to determining new locations of the sample points of the 1D center line.

Preferably, applying the physical particle simulation may be configured to consider at least one of the externally applied tentacle root motion, gravity, wind, waves, and a force of collision with a body.

Preferably, applying the physical particle simulation is configured to consider a random perturbation internal force to generate effects of an autonomic nerve of the tentacle.

Preferably, the method may further include representing a vibration motion by applying an eigen-mode simulation to determining new locations of the sample points of the 2D surface.

Preferably, representing the vibration motion may be configured to represent the vibration motion by linearly coupling five or fewer eigen-modes so as to reduce calculation time.

Preferably, the coupling may be performed to couple a body to the surface of the tentacle using a continuous function, which is differentiable at least once, for natural representation purposes.

Preferably, applying the physical particle simulation may be configured to use at least one of a Mass Spring (MS) method, a Shape Matching (SM) method, and a Super-Helix (SH) method.

Preferably, applying the physical particle simulation may be configured to cut the tentacle when an external force equal to or greater than a preset threshold is applied to a part of the tentacle.

In accordance with another aspect of the present invention to accomplish the above objects, there is provided an apparatus for generating graphic tentacle motions, including an initialization unit for dividing a three-dimensional (3D) tentacle into a one-dimensional (1D) center line and a two-dimensional (2D) surface based on information about an initial mesh of the 3D tentacle; a center line dynamics unit for determining new locations of sample points of the 1D center line in a new frame from initial locations of sample points of the 1D center line, based on a tentacle root motion which is externally applied; a surface dynamics unit for determining new locations of sample points of the 2D surface in a new frame from initial locations of sample points of the 2D surface, based on both the initial locations of the 1D center line sample points and the tentacle root motion which is externally applied; and a coupling unit for coupling the 2D surface to the 1D center line using the locations of the sample points of both the 1D center line and the 2D surface in the new frame, thus generating a shape of the tentacle.

In accordance with a further aspect of the present invention to accomplish the above objects, there is provided a method of repeatedly performing a procedure including generating a graphic tentacle motion, including modeling a tentacle by dividing the tentacle into a center line and a surface, simulating a center line deformation motion using a physical particle system, simulating a surface vibration using an eigen-mode decomposition accompanied by a center line motion, and coupling the surface to the center line, thus generating a shape of the tentacle which is deformed over time.

In accordance with yet another aspect of the present invention to accomplish the above objects, there is provided an apparatus for generating a graphic tentacle motion, including an initialization unit for dividing sample points of a center line of a tentacle and a surface of the tentacle into ellipses using information about an initial model of the tentacle, a center line dynamics unit for simulating the sample points of the center line using a physical particle system, a surface dynamics unit for simulating a vibration eigen-mode of the surface in company with the generated center line, and a coupling unit for coupling the center line and the surface to a body.

### BRIEF DESCRIPTION OF THE DRAWINGS

The above and other objects, features and advantages of the present invention will be more clearly understood from the following detailed descriptions taken in conjunction with the accompanying drawings, in which:

FIG. 1 is a block diagram showing the overall construction of an apparatus for generating graphic tentacle motions according to an embodiment of the present invention;

FIG. 2 is a block diagram showing the detailed construction of the graphic tentacle motion generation unit of FIG. 1;

FIG. 3 is a diagram showing an example of dividing a tentacle into a center line and a surface according to an embodiment of the present invention;

FIG. 4 is a diagram showing three eigen-modes having the lowest frequencies in the vibration motions of a surface according to an embodiment of the present invention; and

FIG. 5 is a flowchart showing the sequential flow of a method of generating graphic tentacle motions according to an embodiment of the present invention.

### DESCRIPTION OF THE PREFERRED EMBODIMENTS

Hereinafter, operating principles of the present invention will be described in detail with reference to the attached drawings. If in the specification, detailed descriptions of well-known functions or configurations may unnecessarily make the gist of the present invention obscure, the detailed descriptions will be omitted. Further, the following terms are defined in consideration of the functionality of the present invention, and may vary according to the intention of a user or an operator, usage, etc. Therefore, the terms should be defined based on the whole contents of the present specification.

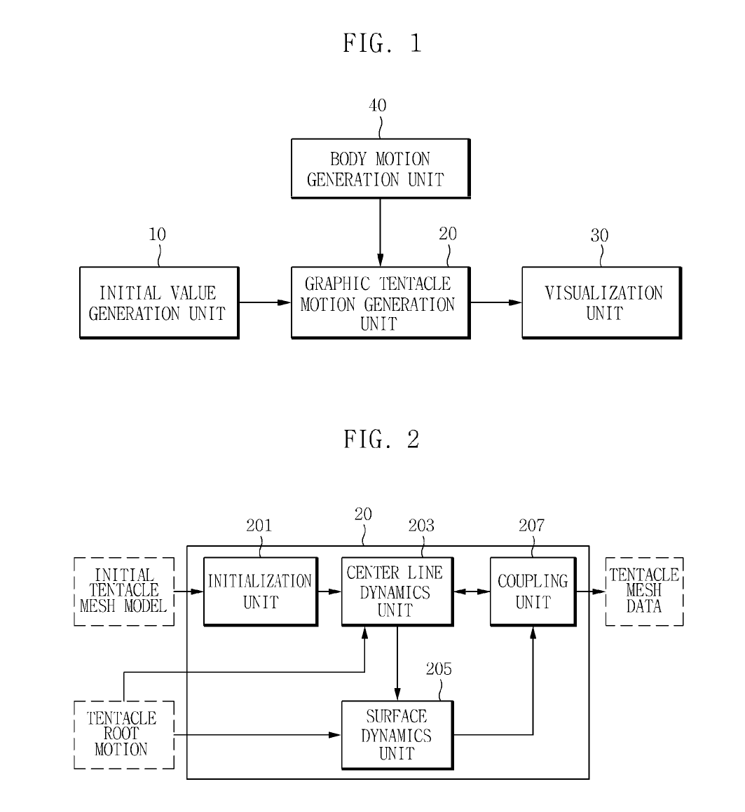

FIG. 1 is a block diagram showing the overall construction of an apparatus for generating graphic tentacle motions according to an embodiment of the present invention.

Referring to FIG. 1, the apparatus for generating graphic tentacle motions according to the embodiment of the present invention includes an initial value generation unit 10, a graphic tentacle motion generation unit 20, a visualization unit 30, and a body motion generation unit 40.

The initial value generation unit 10 functions to provide an initial mesh model of the tentacle for tentacle modeling. In the present invention, the initial value generation unit 10 is an editor program for providing the initial shape of the tentacle. As a commercial program for the initial value generation unit 10, a block which uses one of Maya and 3D Max, or a new program similar thereto, may be employed. The initial value generation unit 10 provides the initial mesh model of the tentacle to the graphic tentacle motion generation unit 20.

Here, the initial mesh model of the tentacle may include tentacles of mollusca, such as an octopus or a cuttlefish, and the tentacles of a jellyfish in computer graphics or the like.

The graphic tentacle motion generation unit 20 models the tentacle by dividing it into a center line and a surface on the basis of the initial mesh model of the tentacle. Accordingly, the time required for calculation can be shortened compared to the existing simulation of the entire three-dimensional (3D) volume.

Further, the graphic tentacle motion generation unit 20 divides the tentacle into the center line and the surface, and then simulates the deformation of the center line which is represented in one dimension by using a physical particle system, thus enabling detail representation of the bending or twisting of the tentacle to be performed without resulting in unnaturalness such as the penetration of the tentacle through a body.

Further, the graphic tentacle motion generation unit 20 divides the tentacle into the center line and the surface, resolves the vibrations of the surface which is represented in two dimensions into eigen-modes, and then automatically generates the vibrations of the surface by coupling several types of typical vibration eigen-modes. Furthermore, the graphic tentacle motion generation unit 20 may perform processing such that when an external force equal to or greater than a threshold is applied to a region of the tentacle simply set by the user, a destruction simulation can be conducted.

The body motion generation unit 40 generates a body motion model which is to be linked to a graphic tentacle motion model generated by the graphic tentacle motion generation unit 20. The body motion generation unit 40 may employ the same scheme as the above-described graphic tentacle motion generation unit 20, but it is not limited to that scheme.

Further, the body motion generation unit 40 generates and provides information about the tentacle root motions which is to be linked to the graphic tentacle.

The visualization unit 30 functions to render and visualize the graphic tentacle motion model generated by the above-described scheme. The visualization unit 30 may be implemented using any scheme as long as the scheme is capable of representing tentacle motion models.

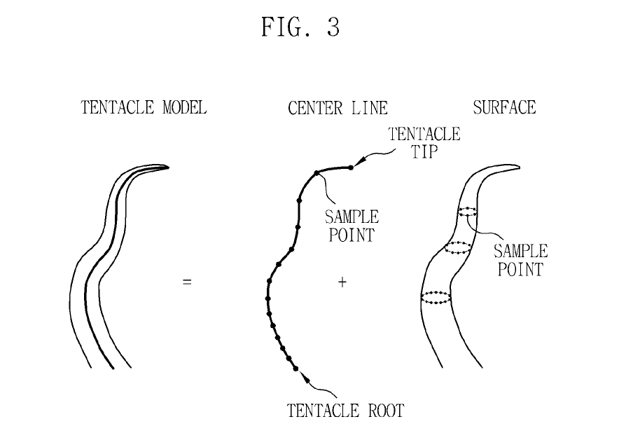

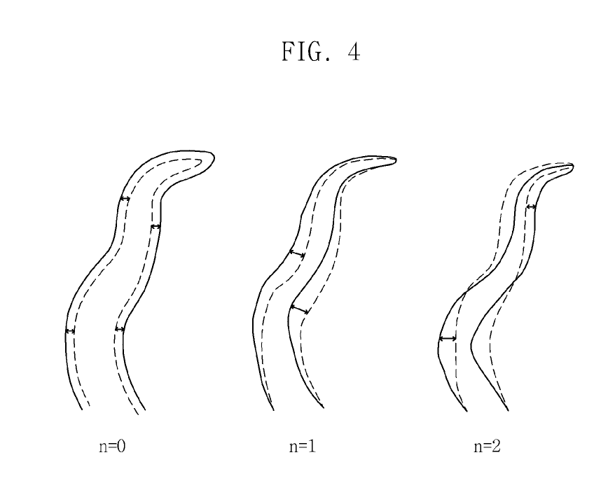

FIG. 2 is a block diagram showing the detailed construction of the graphic tentacle motion generation unit of FIG. 1, FIG. 3 is a diagram showing an example of dividing a tentacle into a center line and a surface according to an embodiment of the present invention, and FIG. 4 is a diagram showing three eigen-modes with the lowest frequencies in the vibration motions of the surface according to an embodiment of the present invention. In FIG. 3, a tentacle model is divided into a center line and a surface (wherein the number of sample points is large near the root and decreases in a direction from the root to the tip, but the tentacle model may be configured such that the number of sample points is small near the root and increases in the direction from the root to the tip). In FIG. 4, the eigen-modes of the vibration motions of the surface are illustrated (where n is an eigen-mode index).

Referring to FIG. 2, the graphic tentacle motion generation unit 20 includes an initialization unit 201, a center line dynamics unit 203, a surface dynamics unit 205, and a coupling unit 207.

The initialization unit 201 divides the tentacle into a one-dimensional (1D) center line and a two-dimensional (2D) surface using 3D mesh information input from the above-described initial value generation unit 10. First, the initialization unit 201 acquires sample points from the 1D center line and samples points from sectional curves constituting the 2D surface. As shown in FIG. 3, the section of the tentacle has a shape which is thick at the root and becomes thinner in a direction from the root to the tip. Therefore, the initialization unit 201 designates the number of sample points on the tentacle surface as a decreasing function in which the number of sample points is large at the root and decreases in a direction from the root to the tip, so that the geometry of the actual tentacle is taken into consideration, thus increasing the sense of reality. Therefore, the tentacle is automatically divided into the center line and the surface with respect to any initial mesh input values of the tentacle, thus eliminating a computational load for the time required to use the 3D volumetric mesh itself.

The center line dynamics unit 203 determines the shape of the center line in a subsequent time frame using a tentacle root motion input from the above-described body motion generation unit 40, that is, the shape of the center line in a current time frame. In more detail, the center line dynamics unit 203 regards sample points constituting the center line as particles having mass and other physical properties in principle. Further, the center line dynamics unit 203 solves the equation of the physical particle system on which external forces such as gravity or internal forces such as elasticity act, determines new locations of particles in successive time frames, and then determines the time-varying shapes of the center line. Accordingly, the center line formed by the center line dynamics unit 203 can represent detail deformation, such as twisting, distortions, and destruction, using the physical particle system. The center line dynamics unit 203 represents the center line by calculating the external forces such as gravity, wind, water waves, or collision, and the internal forces generated by neighboring sample points.

In this case, the center line dynamics unit 203 can cut the center line when the external force applied to a preset region is equal to or greater than a preset threshold in the simulation of the center line. As physical models, a Mass-Spring (MS) system, a Shape-Matching (SM) system, a Super-Helix (SH) system, etc. may be used.

The surface dynamics unit 205 uses eigen-mode resolution to generate the vibration motions of the surface in conformity with the tentacle root motion input from the body motion generation unit 40 and the center line determined by the center line dynamics unit 203. In more detail, as shown in FIG. 4 (n, which is not described, denotes an eigen-mode index), the surface dynamics unit 205 solves a differential equation that uses the given center line and the previous shape of the surface as sources, and calculates only finite vibration modes ranging from a low-frequency vibration to a high-frequency vibration. Further, the surface dynamics unit 205 represents the vibrations of the surface by linearly superposing the finite vibration modes. Accordingly, the surface vibrations generated by the surface dynamics unit 205 approximately represent vibration motions by linearly superposing the finite vibration modes, thus reducing the time required for calculations.

The coupling unit 207 generates a new tentacle mesh in a subsequent time frame using the center line and the surface respectively determined by the center line dynamics unit 203 and the surface dynamics unit 205. Here, the coupling unit 207 configures a tentacle mesh so that the tentacle mesh can be smoothly coupled to a body mesh which is close to the root and has been generated by the body motion generation unit 40, and then generates data that can be rendered by the visualization unit 30.

Therefore, the present invention is advantageous in that, since it provides a systematized pipeline for generating tentacle motions, manual operations can be minimized and calculations can be efficiently processed, and in that, since it divides a tentacle into the center line and the surface, and conducts different suitable simulations on the center line and the surface, animations can be minutely and rapidly processed. Further, the present invention is also advantageous in that the sample points of the center line and the surface of the tentacle are differentially generated depending on a distance to the root, so that a phenomenon in which less variations occur near the root point, and more variations in curves occur near the tip is taken into consideration, thus enabling detail representation.

Hereinafter, a method of generating graphic tentacle motion according to an embodiment of the present invention having the above construction will be described. In the description, the process of generating graphic tentacle motion in the graphic tentacle motion generation apparatus having the above-described construction will be described by way of example.

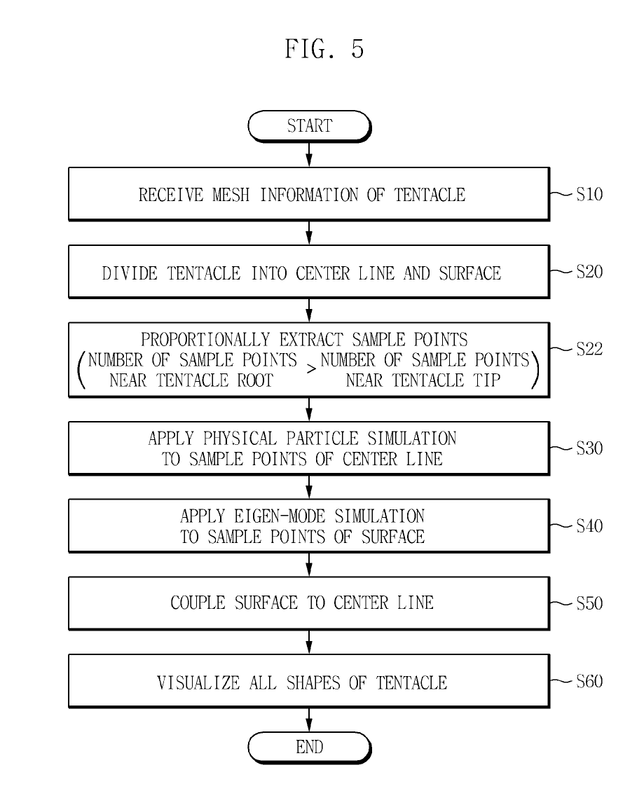

FIG. 5 is a flowchart showing the sequential flow of the method of generating graphic tentacle motions according to an embodiment of the present invention. In the description, components designated by the same reference numerals throughout FIGS. 1 to 4 are assumed to have the same functions.

First, as the initial value generation unit 10 generates and provides information about an initial mesh of each tentacle, the initialization unit 201 of the graphic tentacle motion generation unit 20 receives the initial mesh information of each tentacle at step S10. Further, the initialization unit 201 divides the tentacle into a 1D center line and a 2D surface using the received mesh information of the tentacle at step S20.

In this case, the initialization unit 201 extracts sample points from the 1D center line and the 2D surface at step S22. The initialization unit 201 extracts a larger number of sample points near the tentacle root and a smaller number of sample points in a direction from the root to the tip of the tentacle. That is, the initialization unit 201 uses a larger number of sample points near the tentacle root, and uses a smaller number of sample points in the direction from the root to the tip of the tentacle (refer to FIG. 3).

Next, the center line dynamics unit 203 calculates new locations of the sample points of the center line based on the calculation of an internal force at step S30. That is, the center line dynamics unit 203 calculates an external force, such as gravity, wind, water waves, or collisions, and the internal force generated by neighboring sample points, on the basis of the locations of the sample points of the center line, which have been input from the initialization unit 201 or the coupling unit 207, and information about the location of the root, which has been input from the body motion generation unit 40. The center line dynamics unit 203 calculates the new locations of the sample points of the center line based on the results of the calculation. Here, the center line dynamics unit 203 can cut the center line when the external force applied to a preset region is equal to or greater than a preset threshold in the simulation of the center line. Further, the center line dynamics unit 203 provides the new locations of the sample points of the center line calculated in this way to the surface dynamics unit 205.

Then, the surface dynamics unit 205 calculates the vibration eigen-modes of the motion of the surface using a discrete differential equation on the basis of the root location information input from the body motion generation unit 40 at step S40. In this case, the surface dynamics unit 205 uses a list of locations of previous frames of the center line and a list of locations of new frames of the center line which have been input from the center line dynamics unit 203 when the vibration eigen-modes of the surface motion are calculated (refer to FIG. 4). Accordingly, the surface dynamics unit 205 calculates the vibration motion of the surface by linearly superposing those vibration eigen-modes.

After steps S30 and S40 have been performed, the locations of the sample points of the center line and the surface, respectively calculated by the center line dynamics unit 203 and the surface dynamics unit 205, are provided to the coupling unit 207.

Finally, the coupling unit 207 generates the mesh of the tentacle using information about the locations of the center line and the surface, which have been input from the center line dynamics unit 203 and the surface dynamics unit 205 at step S50. In this case, the coupling unit 207 suitably controls the sample points so that the surface is smoothly coupled to the body near the root.

After step S50, the coupling unit 207 may continuously accumulate the pieces of mesh information of the tentacle in new frames and may provide the mesh information of all frames to be visualized to the visualization unit 30 at step S60.

Meanwhile, after step S50, the coupling unit 207 may provide the mesh information of the tentacle in the new frames to the center line dynamics unit 203 at step S30, and may use the mesh information to calculate new locations of the sample points of the center line.

As described above, the present invention can automatically divide each tentacle into a center line and a surface with respect to the input values of any initial mesh of the tentacle, and can eliminate a computational load for the time required to use a 3D volumetric mesh. In this case, the deformation of the center line, such as twisting, distortions or destruction thereof, can be minutely represented using a physical particle system. Further, with regard to surface vibrations, vibration motions may be approximately represented by linearly coupling finite eigen-modes, thus reducing the calculation time.

Further, the present invention is very useful when rapidly and effectively visualizing the deformation and vibration motions of a tentacle, and is applied to the animation of tentacles of mollusca such as an octopus or a cuttlefish and the tentacles of a jellyfish, thus efficiently generating high-quality images of tentacles.

As described above, the present invention provides a systematized pipeline for generating tentacle motions, thus minimizing manual operations and efficiently processing calculations.

Further, the present invention generates a tentacle model by dividing a tentacle into a 1D center line and a 2D surface, instead of a 3D mesh, thus reducing the time required for calculations.

Furthermore, the present invention performs a physical particle system-based simulation on a 1D center line, thus enabling detail representations of deformation, such as the bending or twisting of the tentacle, to be performed.

Furthermore, the present invention resolves the vibrations of a 2D surface into eigen-modes, and represents the vibration motions of the surface by linearly coupling finite important eigen-modes, thereby enabling animation to be rapidly realized.

Furthermore, the present invention enables a destruction simulation, such as the cutting of a tentacle attributable to an external force, to be implemented using simple settings made by a user.

Furthermore, the present invention is advantageous in that it is very useful to rapidly and effectively visualize the deformation and vibration motions of a tentacle, and it is applied to the physical particle system-based animation of the tentacles of animals such as a cuttlefish, an octopus, and a jellyfish in computer graphics, thus efficiently generating high-quality images.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention is not limited to the above-described embodiments, and should be defined by the accompanying claims and equivalents thereof.

What is claimed is:

1. A method of generating graphic tentacle motions, comprising:
dividing a three-dimensional (3D) tentacle into a center line and a surface based on information about an initial mesh of the 3D tentacle;
determining new locations of sample points of the center line in a new frame from initial locations of sample points of the center line, based on a tentacle root motion which is externally applied;
determining new locations of sample points of the surface in the new frame from initial locations of sample points of the surface, based on both the initial locations of the center line sample points and the tentacle root motion; and
coupling the surface to the center line using the locations of the sample points of both the center line and the surface in the new frame, thus generating a smooth shape of the tentacle.

2. The method of claim 1, further comprising repeatedly performing the line-surface coupling on each new frame, thus generating shapes of the tentacle that is being deformed over time.

3. The method of claim 1, wherein determining new locations of the sample points of the center line comprises:
determining initial locations of the sample points of the center line based on the externally applied tentacle root motion; and
determining new locations of the sample points of the center line, which define a shape of the center line in a subsequent frame, based on both locations of the sample points of the center line and the externally applied tentacle root motion.

4. The method of claim 1, wherein determining new locations of the sample points of the surface comprises:
determining initial locations of the sample points of the surface based on the externally applied tentacle root motion; and
determining new locations of sample points of the surface in the subsequent frame based on the locations of the sample points of the surface, the locations of the sample points of the center line, and the externally applied tentacle root motion.

5. The method of claim 1, wherein the sample points of the center line is distributed in considering of a geometrical structure of the tentacle to increase a sense of reality, and by using adaptive sampling in which a number of sample points distributed at the tentacle root and a number of sample points distributed at the tentacle tip are differently set.

6. The method of claim 1, wherein the sample points of the surface is distributed in considering of a geometrical structure of the tentacle to increase a sense of reality, and by using adaptive sampling in which a number of sample points distributed at the tentacle root and a number of sample points distributed at the tentacle tip are differently set.

7. The method of claim 1, further comprising applying a physical particle simulation, which includes at least one of twisting, bending and destruction, to determining new locations of the sample points of the center line.

8. The method of claim 7, wherein applying the physical particle simulation is configured to consider at least one of the externally applied tentacle root motion such as gravity, wind, waves, and a force of collision with a body.

9. The method of claim 7, wherein applying the physical particle simulation is configured to consider a random perturbation internal force to generate effects of an autonomic nerve motion of the tentacle.

10. The method of claim 1, further comprising representing a vibration motion by applying an eigen-mode simulation to determining new locations of the sample points of the surface.

11. The method of claim 10, wherein representing the vibration motion is configured to represent the vibration motion by linearly coupling five or fewer eigen-modes so as to reduce calculation time.

12. The method of claim 1, wherein the coupling is performed to couple a body to the surface of the tentacle using a continuous function, which is differentiable at least once.

13. The method of claim 7, wherein applying the physical particle simulation is configured to use at least one of a Mass Spring (MS) method, a Shape Matching (SM) method, and a Super-Helix (SH) method.

14. The method of claim 7, wherein applying the physical particle simulation is configured to cut the tentacle when an external force equal to or greater than a preset threshold is applied to a part of the tentacle.

15. An apparatus for generating graphic tentacle motions, comprising:
an initialization unit for dividing a three-dimensional (3D) tentacle into a center line and a surface based on information about an initial mesh of the 3D tentacle;
a center line dynamics unit for determining new locations of sample points of the center line in a new frame from initial locations of sample points of the center line, based on a tentacle root motion which is externally applied;
a surface dynamics unit for determining new locations of sample points of the surface in a new frame from initial locations of sample points of the surface, based on both the initial locations of the center line sample points and the tentacle root motion which is externally applied; and
a coupling unit for coupling the surface to the center line using the locations of the sample points of both the center line and the surface in the new frame, thus generating a shape of the tentacle.

16. The apparatus of claim 15, wherein the coupling unit repeatedly performs the line-surface coupling on new frames, thus generating a shape of the tentacle that is deformed over time.

17. The apparatus of claim 15, wherein the center line dynamics unit is configured to determine initial locations of the sample points of the center line based on the externally applied tentacle root motion, and determine new locations of the sample points of the center line, which define a shape of the center line in a subsequent frame, based on both locations of the sample points of the center line and the surface and the externally applied tentacle root motion.

18. The apparatus of claim 15, wherein the surface dynamics unit is configured to determine initial locations of the sample points of the surface based on the externally applied tentacle root motion, and determine new locations of sample points of the surface in the subsequent frame based on the locations of the sample points of the surface, the locations of the sample points of the center line, and the externally applied tentacle root motion.

19. The apparatus of claim 15, wherein the center line dynamics unit is configured to apply a physical particle simulation, which includes at least one of twisting, bending and destruction, to the new locations of the sample points of the center line.

20. The apparatus of claim 15, wherein the surface dynamics unit is configured to represent a vibration motion by applying an eigen-mode simulation to the new locations of the sample points of the surface.
